(19) United States
(12) Patent Application Publication
(10) Pub. No.: US 2025/0273940 A1
(43) Pub. Date: Aug. 28, 2025

(54) HOLDER FOR PLACEMENT IN AND/OR AGAINST AN OPENING IN A CONSTRUCTION ELEMENT AND FOR HAVING CABLES SEALINGLY EXTENDING THROUGH CHANNELS IN THE HOLDER

(71) Applicant: Beele Engineering B.V., Aalten (NL)

(72) Inventor: Johannes Alfred Beele, Aalten (NL)

(73) Assignee: Beele Engineering B.V., Aalten (NL)

(21) Appl. No.: 18/859,766

(22) PCT Filed: Apr. 25, 2023
(86) PCT No.: PCT/NL2023/050222

§ 371 Date: Oct. 24, 2024

(30) Foreign Application Priority Data
Apr. 25, 2022 (NL) 2031700

(51) Int. Cl. H02G 3/04

(52) U.S. Cl. CPC H02G 3/0456

(57) ABSTRACT

Holder for placement in and/or against an opening in a construction element, wherein the holder is provided with a flange for extending outside of the opening beyond a perimeter of the opening, the holder further being provided with a plurality of channels for hosting in each channel at least one cable for extending from one side of the holder to another side of the holder, wherein the holder is of a material that predominantly comprises rubber.

The disclosure relates to a holder for placement in, or in front of, an opening in a construction element. The holder is provided with a flange for extending outside of the opening beyond a perimeter of the opening. The holder is further provided with a plurality of channels for hosting in each channel at least one cable for extending from one side of the holder to another side of the holder.

### BACKGROUND OF THE DISCLOSURE

As known, transmission of optical and electrical signals can take place wirelessly but can also take place through a wire of a material that is suitable for propagation therethrough of the respective signal. For a secure transmission of information wires are often preferred over a wireless transmission.

The same applies to transport of energy for providing electrical energy. It is not impossible to transport energy wirelessly, for instance by means of induction, but most of the electrical energy is reliably transported by means of cables.

Both, transmission of signals (data) and transport of energy, have seen a massive increase in demand. Often, the transmission and/or the transport takes place from one space into another space that is separated from the one space by means of a construction element. Such a construction element can be a metal plate, a concrete wall, or any other material that is suitable as a construction element. The construction element may be dimensioned and of a material to withstand at least for some time, for instance, pressure due to for instance a load by a height of water, permeation of water through the construction element, exposure to a nearby fire, propagation of a fire through the construction element etc.

Instead of making for each cable a hole in the construction element for enabling the cable to extend from the one space to the other through the construction element, often an opening is made such that multiple cables can transit from the one space through the construction element to the other space.

A framework having channels, each for extending therethrough one or more cables, can be provided for placement in and/or against the opening. The framework has a flange to ensure overlap between a part of the construction element that surrounds the opening and the framework. The flange may be provided with through-holes for allowing fixation of the framework to the construction element. Usually, a gasket is provided in-between the construction element and the framework to ensure that the framework is in a sealing fashion fixed to the construction element. The channels in the framework can be sealed off by rubber plugs. These rubber plugs may comprise a blind plug for sealing a channel through which no cable extends and may also comprise a plug that can occupy an annular space that is formed between an inner wall of a channel and a cable extending through that channel. Such latter plugs can have outer dimensions that are determined by the diameter of the respective channels, and inner diameters that are determined by the diameter of the cable that extends through the respective channel. Known frameworks are generally made of an engineering plastic, but may equally be made of a metal, such as for instance aluminium or steel. EP 2703705 A1, discloses such frameworks in FIGS. 4 and 5.

The transition of cables from one side of a construction element—through the construction element—to another side of the construction element, are often referred to as a cable penetration.

Frameworks of an engineering plastic or of a metal are relatively inflexible when the construction element deform due to a changing dynamic situation. For instance, pressure on the construction element dynamically increased by water load may lead to such a deformation. Bulging of the construction element may not be well accommodated for by such a framework.

Frameworks suitable for bolting to a part of the construction element that surrounds an opening need a gasket between the flange of the framework and that part of the construction element. Such gasket may be forgotten, and/or may be incorrectly applied, undermining the sealing integrity.

Frameworks made of metal, may on exposure to heat result in thermal expansions which differ between the framework and the construction element, which may ultimately lead to deformations that undermine the sealing integrity of the cable penetration. In more detail, if the construction element is of metal and the framework is of metal then the unequal expansion may cause much stresses, potentially leading to detachment or fracturing of the framework where it joined the construction element. Further the deformation of the framework may also lead to a change in the dimensions of the channels in the framework. The sealing plugs may not fit well anymore and lead to leaks or even to loosening of the rubber plugs out of the channels.

The same problems of unequal thermal expansion may actually rise when the holder is made of an engineering plastic and the construction element is made of another material, be it of metal of for instance of concrete.

Another problem is the installation of a metal framework onto, or into, the opening in the construction element. This requires highly skilled workers when welding activities are needed. The exposure of these workers to unhealthy working conditions makes it undesirable to use such frameworks.

There is a need to provide a framework that addresses at least one of the above problems.

### SUMMARY OF THE DISCLOSURE

The disclosure provides a holder for placement in and/or against an opening in a construction element. The holder is provided with a flange for extending outside of the opening beyond a perimeter of the opening. The holder further being provided with a plurality of channels for hosting in each channel at least one cable for extending from one side of the construction element to another side of the construction element. The holder is of a material that predominantly comprises rubber. This contributes to an ability of the holder to sustain deformation of the construction element and possibly also deformation of any fixing elements for fixing the holder against the construction element. In an embodiment, the holder is of rubber, to maximize resiliency. The holder itself is thus preferably in its entirety of rubber.

In an embodiment, the rubber is a ceramifiable rubber. Such rubbers contain fillers that facilitate stabilization of the shape of the holder whilst being exposed to a nearby fire and thus to heat and oxygen. The stabilization results from transforming the rubber into a ceramic instead of being consumed or weakened. The holder, and to an extent also the sealing integrity of the holder, may last much longer as compared to a holder that is made of a rubber that deforms, weakens and/or is consumed during exposure to a nearby fire. Due to the high filler rate, the rubber has also under normal atmospheric conditions, i.e. without exposure to a nearby fire, a hardness that reflects a high stability in terms of the shape of the holder. In an embodiment, the rubber is a silicone-based rubber. The rubber silicone-based holder as properly placed into or onto an opening in a construction element does not require the need for a silicone-based sealant which is otherwise often used for sealing off cable penetrations.

In an embodiment, the holder is part of a system that includes at least one sealing plug for sealing off at least one of the plurality of channels. In an embodiment, the holder is part of a system that includes at least one sealing plug for sealing off at least one of the plurality of channels when that at least one channel hosts at least one cable which extends from one side of the holder to another side of the holder. Also such plugs avoid the need for use of a sealant. Relative to a sealant which needs time for curing, the sealing integrity is immediately given when the plug has been inserted in the respective channel of the holder.

In an embodiment, each of the at least one sealing plugs is of a rubber that has a Shore A hardness that is lower that the Shore A Hardness of the rubber of the holder. Preferably, the Shore A hardness of the rubber of the holder is about 76 shore A and the Shore A Hardness of the rubber of the plugs is about 74 Shore A. This ensures that in an embodiment, the sealing plugs can accommodate for fitting in the channel and accommodate for relatively high tolerances in the diameters of cables. The rubber of the at least one sealing plug may also be a silicone-based rubber.

In an embodiment the holder is provided with a gasket for placing the holder so that the gasket seals between the flange and an endless part of the construction element that completely surrounds the perimeter of the opening. The gasket is preferably an integral part of the holder as the gasket and the holder are each part of the same monolithic product. As the gasket is part of the holder, it is not possible to forget the gasket, or to place the gasket incorrectly relative to the holder.

In an embodiment of the holder, the gasket comprises a face for abutting against the endless part of the construction element, the face comprising structures for enclosing air between the gasket and the endless part. It has turned out that such structures can very easily accommodate for thermal expansion of for instance the construction element, so that sealing integrity remains maintained upon exposure to relatively high temperatures. Further the inclusion of air pockets provide a form of thermal insulation between the holder and the construction element. In case of a nearby fire which heats up the construction element, a thermal barrier between the holder and the construction element can thus be in place, which assists in a longer time during which the holder can sustain the nearby fire when compared to a situation in which no air pockets can be formed between the holder and the construction element.

In an embodiment of a holder, the structures comprise a plurality of ridges that extend at least in a direction along a perimeter of the flange. The construction element which is most often substantially plate-shaped, potentially causes upon thermal expansion, slight displacement of the surface of the construction element in a direction that is across the direction in which the ridges extend, so that the frictional resistance imposed by the ridge can relatively easily be overcome and the thermal expansion-and upon cooling the thermal shrinkage-of the construction material can be accommodated for whilst maintaining the sealing integrity. Preferably, the ridges are endless.

In an embodiment of a holder, the flange is provided with a number of through-holes, each through-hole for extending a fixing element therethrough for fixing the holder against the construction element. This embodiment allows for a very simple way of preparing a construction element for having a cable penetration therethrough. In the construction element an opening needs to be made which allows for the holder to be placed such that the flange has overlap with a part of the construction element that surrounds the opening. The opening is further generally made such that the cables can in a parallel fashion and with distance from each other be passed through the opening from one side of the construction element to another side of the construction element. If the construction element is of a material that can be made by casting, then the opening may be casted in. This applies to concrete, plastic, but even to metals such as cast iron. If the material is plate-shaped, it may be easier to cut or machine out the material, so as to make the opening. Another step is the making of through-holes distanced from each other around the opening, so as to match with positions of the through-holes in the flange of the holder when the holder is placed in its end- position into or onto the opening. Also these through-holes may be prefabricated simultaneously with the making of the construction element or machined, or may be made for instance by drilling through the construction element. Note that relatively simple skills are required. For fixing the holder into or onto the opening, no welding is required.

In an embodiment, each through-hole is surrounded by a ridge that completely surrounds the through-hole. This prevents the through-hole from undermining the entrapment of air between the holder and the construction element. The entrapment of air is relevant as explained above in view of thermal insulation. However, the entrapment of air may also provide a cushioning effect, in mechanical terms.

The present disclosure is also related to a method of making, for instance by injection moulding, at least two of such holders of rubber which have the same overall outer dimensions, but of which at least one of the holders has a first pattern of channels and at least a second one has a second pattern of channels, wherein the first pattern and the second pattern differ at least in one of number, dimensions and positions of channels, wherein the method comprises:
1. providing a mould having a cavity for making a holder having overall outer dimensions of a first type therein;
   a. placing cores in the cavity of the mould so that a holder having the first pattern of channels is produced when the holder is made in the cavity;
   b. making in the cavity the holder having the first pattern of channels;
2 providing the mould having a cavity for making a holder having overall outer dimensions of a first type therein;
   a. placing cores in the cavity of the mould so that a holder having the second pattern of channels is produced when the holder is made in the cavity;
   b. making in the cavity the holder having the second pattern of channels:

Advantageously, only one mould needs to be provided for making holders with different channels in terms of the number, the positions, and the dimensions of the channels. This greatly reduces the costs and allows for tailor-making the holders. The cores can be made to meet the specifications of a specific holder. Making the cores is a matter of fairly simple and straightforward machining.

### SHORT DESCRIPTION OF THE DRAWING

The disclosure is further described and explained with reference to the drawing, of which:

FIG. 1 shows an embodiment of a holder according to the disclosure whilst viewing an insertion side for inserting sealing plugs;

FIG. 2 shows an embodiment of a holder according to the disclosure in a perspective view from a side that is opposite the insertion side; and

FIG. 3 shows an embodiment of a holder according to the disclosure whilst viewing in a direction in which ridges on a part of a flange extend.

### DETAILED DESCRIPTION OF THE DISCLOSURE

In the drawing, specific parts are labelled with a reference number. Like parts are referenced by like reference numbers.

Engineered constructions comprise a lot of construction elements. Sometimes these elements delimit compartments. Then such construction elements are often plate-shaped. Through engineered constructions, often cables extend from one compartment to another. For that purpose, openings are formed in the construction elements, so that multiple cables can extend through the opening from one apartment to another compartment, or to a surrounding outside any compartment. In general, the openings are sealed off, so that only the cables extend through the sealed off opening. Such a construction is often referred to as a cable penetration.

A purpose of the sealing is to prevent for instance gas, smoke, liquid, sound etc. to be transported through the opening from one compartment to another or to a surrounding of the compartment. In case of a fire, this is even more important, as the sealing, if appropriately chosen, can block the spreading of a fire and contain the fire in a compartment for as long as possible. Particularly on board of vessels and off-shore constructions this is highly relevant, as it may take some time before rescue services can be on-site.

The sealing can be provided by a holder having channels through which one or more cables can extend. The channels can be sealed off, and the holder can be applied such that the opening is sealed off between the construction element and a periphery of the holder.

FIG. 1 shows a holder 1 for placement in and/or against an opening in a construction element. The holder is provided with a flange 2 for extending outside of the opening beyond a perimeter of the opening. The holder is further provided with a plurality of channels 3 for hosting in each channel 3 at least one cable for extending from one side of the holder to another side of the holder. The shape of a holder and a system of which such a holder may be a part, can be found in EP2703705, and particularly to FIG. 1-5, but also in EP 1892448, of which particularly FIG. 12-16 show a holder. For examples of sealing plugs reference is made to WO2007/07342, particularly FIGS. 12 and 13. The holder is preferably provided with a gasket 4 for placing the holder so that the gasket 4 is able to provide a seal between the flange 2 and an endless part of the construction element that completely surrounds the perimeter of the opening. When the opening is circular, the endless part would be the ring-shaped part that surround the perimeter of the opening.

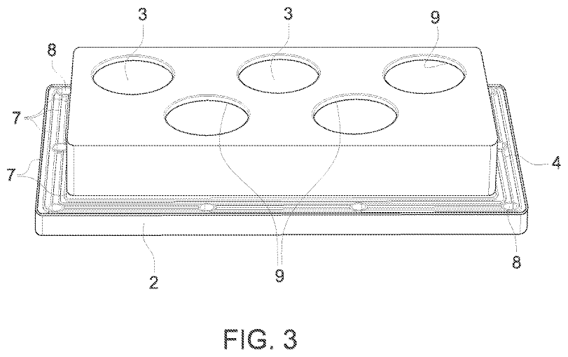

Gasket 4 is preferably an integral part of the holder 1 as the gasket 4 and the holder 1 are each part of the same monolithic product. Preferably, the gasket 4 is an integral part of the flange 2. The gasket 4 comprises a face 5 for abutting against the endless part of the construction element. The face comprising structures 6 for enclosing air between the gasket and the endless part. The structures 6 preferably comprise a plurality of ridges 7 that extend at least in a direction along a perimeter of the flange. As shown in FIG. 3, four ridges extend in a parallel fashion along each other in a circumferential direction of the flange 2.

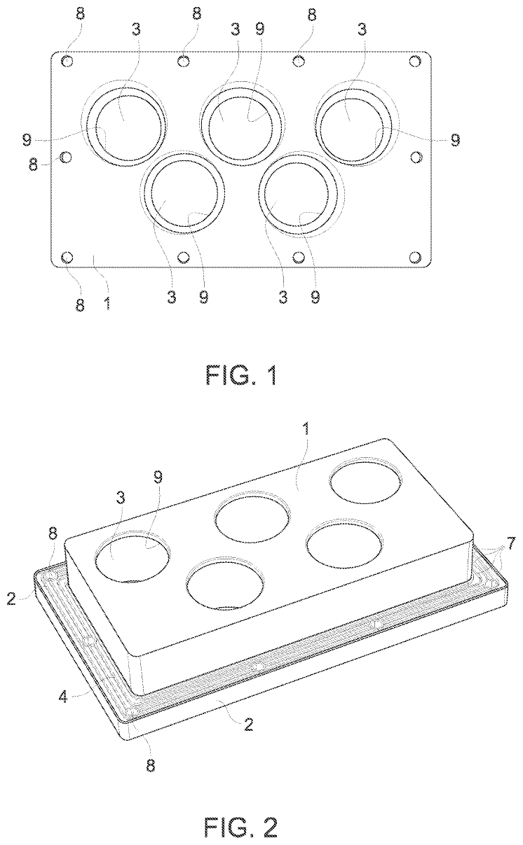

The flange is provided with a number of through-holes 8, each through-hole for extending a fixing element (not shown) therethrough for fixing the holder 1 against the construction element. The holder may be a part of a system that includes a number of fixing elements. Each fixing element comprises a bolt. Each bolt may be provided with a sealing washer that snugly fits around the bolt. As shown in FIGS. 2 and 3, each through-hole is surrounded by a ridge 7 that completely surrounds the through-hole 8.

The holder is made of a material that predominantly comprises rubber. Preferably, the holder is of rubber, preferably in its entirety, and even more preferably the holder is of a ceramifiable rubber. It is possible that the rubber is a silicone-based rubber, to which for instance many fillers have been added to enhance the ceramifiability.

The holder may be part of a system that further includes at least one sealing plug for sealing off at least one of the plurality of channels 3. Preferably, the holder is part of a system that includes at least one sealing plug for sealing off at least one of the plurality of channels when that at least one channel hosts at least one cable for extending from one side of the holder to another side of the holder. As indicate above, examples of such sealing plugs are given in WO2007/07342, particularly FIGS. 12 and 13. It is also possible that plugs for hosting only one cable, or just two cables or 4 or 5 and even more cables, are part of a system of which also the holder 1 is a part.

Each of the at least one sealing plugs is of a rubber that has a Shore A hardness that is lower that the Shore A Hardness of the rubber of the holder. For instance, Shore A hardness of the rubber of the holder is about 76 shore A and the Shore A Hardness of the rubber of the plugs is about 74 Shore A.

Also, the rubber of the at least one sealing plug may a ceramifiable rubber, and the rubber of the at least one sealing plug is a silicone-based rubber.

The channels 3 in the holder 1 are preferably provided with a blocking element 9, that may be circumferentially extending within this channel 3. The blocking element may be at an end that is opposite an end at which the respective sealing plug is inserted for sealing off that channel 3. This prevents the sealing plug from being inserted too deeply and/or prevents the sealing plug from extending out of the other end of the channel 3. The blocking element 9 may thus retain the sealing plug in the respective channel 3. The length of the sealing plugs is usually equal to the length of the channel 3 measured from the outer face of the holder 1 at the side at which the sealing plugs can be inserted up to the blocking element 9.

The flange 2 is relatively thin compared to the part of the holder 1 through which the channels 3 extend. The thickness of the flange is about 20 to 25% of the overall thickness of the holder.

May variations are possible. The holder 1 does not need to be rectangular in shape, but may also be circular, oval, hexagonal etc. The way the channels 3 are distributed may be different. The diameters of the various channels 3 may differ. Further the length of the channels 3 may differ. Possibly also the thickness of the holder 1 at the more central part through which the channels extend, may differ over the holder 1.

The structures that are part of the gasket may equally be different. In general, these extend along the periphery of the holder, i.e. extend in a direction into which the flange 2 extends. However, it is possible that ridges 7 also extend in another direction, for instance also such that the ridges 7 extend across the ridges 7 which extend in a peripheral direction of the holder.

The holder can be made by standard techniques, for instance by high pressure injection moulding of unvulcanised and/or vulcanizable rubber which is conditioned to vulcanize in a mould under exposure to an elevated temperature.

The disclosure also envisages a method for making, for instance by injection moulding, embodiments of at least two holders, wherein the at least two holders have the same overall outer dimensions, and of which at least one of the holders has a first pattern of channels and at least a second one has a second patten of channels, wherein the first pattern and the second pattern differ at least in one of number, dimensions and positions of the channels, the method comprises:
A. providing a mould having a cavity for making a holder having overall outer dimensions of first type therein,
   1 placing cores in the cavity of the mould so that a holder having the first pattern of channels is produced when the holder is made in the cavity;
   2 making in the cavity the holder having the first pattern of channels;
B providing the mould having a cavity for making a holder having verall outer dimensions of a first type therein;
   1 placing cores in the cavity of the mould so that a holder having the second pattern of channels is produced when the holder is made in the cavity
   2 making in the cavity the holder having the second pattern of channels by injection moulding.

1. A holder for placement in and/or against an opening in a construction element, wherein the holder is provided with a flange for extending outside of the opening beyond a perimeter of the opening, the holder further being provided with a plurality of channels for hosting in each channel at least one cable for extending from one side of the holder to another side of the holder, wherein the holder is of a material that predominantly comprises rubber.

2. The holder according to claim 1, wherein the holder is of rubber.

3. The holder according to claim 2, wherein the rubber is a ceramifiable rubber.

4. The holder according to claim 1, wherein the rubber is a silicone-based rubber.

5. The holder according to claim 1, wherein the holder is part of a system that further includes at least one sealing plug for sealing off at least one of the plurality of channels.

6. The holder according to claim 1, wherein the holder is part of a system that further includes at least one sealing plug for sealing off at least one of the plurality of channels when that at least one channel hosts at least one cable for extending from one side of the holder to another side of the holder.

7. The holder according to claim 5, wherein each of the at least one sealing plug is of a rubber that has a Shore A hardness that is lower that the Shore A Hardness of the rubber of the holder.

8. The holder according to claim 7, wherein Shore A hardness of the rubber of the holder is about 76 shore A and the Shore A Hardness of the rubber of the at least one sealing plug is about 74 Shore A.

9. The holder according to claim 7, wherein the rubber of the at least one sealing plug is a ceramifiable rubber.

10. The holder according to claim 6, wherein the rubber of the at least one sealing plug is a silicone-based rubber.

11. The holder according to claim 1, wherein the holder is part of a system that further includes a gasket for placing the holder so that the gasket seals between the flange and an endless part of the construction element that completely surrounds the perimeter of the opening.

12. The holder according to claim 11, wherein the gasket is an integral part of the holder, such that the gasket and the holder are each part of the same monolithic product.

13. The holder according to claim 11, wherein the gasket comprises a face for abutting against the endless part of the construction element, the face comprising structures for enclosing air between the gasket and the endless part.

14. The holder according to claim 13, wherein the structures comprise a plurality of ridges that extend at least in a direction along a perimeter of the flange.

15. The holder according to claim 1, wherein the flange is provided with a number of through-holes, each through-hole for extending a fixing element therethrough for fixing the holder against the construction element.

16. The holder according to claim 15, wherein the holder is part of a system that includes a number of fixing elements.

17. The holder according to claim 16, wherein each fixing element comprises a bolt.

18. The holder according to claim 17, wherein each bolt is provided with a sealing washer.

19. The holder according to claim 15, wherein each through-hole is surrounded by a ridge that completely surrounds the through-hole.

20. A method of making, for instance by injection moulding, at least two holders according to claim 1, wherein the at least two holders have the same overall outer dimensions, and of which at least one of the holders has a first pattern of channels and at least a second one of the holders has a second pattern of channels, wherein the first pattern and the second pattern differ at least in one of number, dimensions and positions of the channels, the method comprising:
providing a mould having a cavity for making a holder having overall outer dimensions of a first type therein;
placing cores in the cavity of the mould so that a holder having the first pattern of channels is produced when the holder is made in the cavity;
making in the cavity the holder having the first pattern of channels;
providing the mould having a cavity for making a holder having overall outer dimensions of a first type therein;
placing cores in the cavity of the mould so that a holder having the second pattern of channels is produced when the holder is made in the cavity; and
making in the cavity the holder having the second pattern of channels.

21. (canceled)
